(19) United States
(12) Patent Application Publication
(10) Pub. No.: US 2013/0174248 A1
(43) Pub. Date: Jul. 4, 2013

(54) PORTABLE DATA-STORAGE DEVICE CONFIGURED TO ENABLE A PLURALITY OF HOST DEVICES SECURE ACCESS TO DATA THROUGH MUTUAL AUTHENTICATION

(71) Applicant: Donald J. Molaro, Cupertino, CA (US)

(72) Inventor: Donald J. Molaro, Cupertino, CA (US)

(21) Appl. No.: 13/340,635

(22) Filed: Dec. 29, 2011

(51) Int. Cl. G06F 12/14

(52) U.S. Cl. 726/17

(57) ABSTRACT

A portable data-storage device configured to enable a plurality of host devices secure access to data through mutual authentication. The portable data-storage device includes a storage-device enclosure, a data-storage medium, a data-writing element, a data-reading element, and an electronic authenticator. The data-writing element and the data-reading element are configured to write data to, and to read the data from, the data-storage medium. The electronic authenticator is configured to mutually authenticate the portable data-storage device with a first host device, and at least a second host device. The electronic authenticator is configured to enable secure access to the data on the data-storage medium by the first host device and by the second host device, if the electronic authenticator mutually authenticates the portable data-storage device with the first host device and with the second host device. A method and system configured to enable host devices secure access to data are also provided.

### TECHNICAL FIELD

Embodiments of the present invention relate generally to the field of portable data-storage devices, and in particular to the distribution of content with portable data-storage devices.

### BACKGROUND

Consumers demand portability of content. The popularity of digital versatile disks (DVDs), compact discs (CDs), MPEG-players, smart phones, and tablet computers attest to this consumer preference. Moreover, consumers have grown accustomed to the long-standing “First Sale Doctrine” that gives consumers the right to resell, gift, rent out, or even destroy a consumer-purchased copy of media containing copyrighted content such as: books, tapes, DVDs, and some other forms of media containing copyrighted content. Time-shifting of the display of broadcast content at times different from when it is broadcast is another manifestation of the consumer preference for portability of content, albeit portability in the time domain, reflected in such early technologies as video cassette recorders (VCRs), and most recently digital video recorders (DVRs). Thus, engineers and scientists engaged in the development of technology directed towards the distribution of content are becoming increasingly more interested in methods and devices for satisfying these consumer preferences.

### SUMMARY

Embodiments of the present invention include a portable data-storage device configured to enable a plurality of host devices secure access to data through mutual authentication. The portable data-storage device includes a storage-device enclosure, a data-storage medium, a data-writing element, a data-reading element, and an electronic authenticator. The data-storage medium is enclosed in the storage-device enclosure. The data-writing element and the data-reading element are configured, respectively, to write data to, and to read the data from, the data-storage medium. The electronic authenticator is configured to mutually authenticate the portable data-storage device with a first host device, and at least a second host device. The electronic authenticator is configured both to enable secure access to the data on the data-storage medium by the first host device if the electronic authenticator mutually authenticates the portable data-storage device with the first host device, and to enable secure access to the data on the data-storage medium by the second host device if the electronic authenticator mutually authenticates the portable data-storage device with the second host device. Embodiments of the present invention also include a system configured to enable a plurality of host devices secure access to data stored on a portable data-storage device through mutual authentication, and a method for enabling a plurality of host devices secure access to data stored in a portable data-storage device through mutual authentication.

### DESCRIPTION OF THE DRAWINGS

The accompanying drawings, which are incorporated in and form a part of this specification, illustrate embodiments of the invention and, together with the description, serve to explain the embodiments of the invention:

FIG. 1 is a block diagram of a portable data-storage device configured to enable a plurality of host devices secure access to data through mutual authentication, in accordance with one or more embodiments of the present invention.

FIG. 2 is a schematic diagram illustrating the arrangement of components within an example portable data-storage device of FIG. 1, a portable hard-disk drive (HDD), configured to enable an example host device of the plurality of host devices secure access to data through mutual authentication, in accordance with one or more embodiments of the present invention.

FIG. 3 is a block diagram of an example system configured to enable the plurality of host devices secure access to data stored on the portable data-storage device of FIG. 1 through mutual authentication, including a first host device and the portable data-storage device, in accordance with one or more embodiments of the present invention.

FIG. 4 is a block diagram of another example system configured to enable a plurality of host devices secure access to data stored on a portable data-storage device of FIG. 1 through mutual authentication, including the first host device, at least a second host device and the portable data-storage device, in accordance with one or more embodiments of the present invention.

FIG. 5 is a flowchart of a method for enabling a plurality of host devices secure access to data stored in a portable data-storage device through mutual authentication, in accordance with one or more embodiments of the present invention.

The drawings referred to in this description should not be understood as being drawn to scale except if specifically noted.

### DESCRIPTION OF EMBODIMENTS

Reference will now be made in detail to the alternative embodiments of the present invention. While the invention will be described in conjunction with the alternative embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of the present invention. However, it should be appreciated that embodiments of the present invention may be practiced without these specific details. In other instances, well known methods, procedures, and components have not been described in detail as not to unnecessarily obscure embodiments of the present invention. Throughout the drawings, like components are denoted by like reference numerals, and repetitive descriptions are omitted for clarity of explanation if not necessary.

### Physical Description of Embodiments of a Portable Data-storage Device Configured to Enable a Plurality of Host Devices Secure Access to Data Through Mutual Authentication

Throughout the following, by way of example, a portable hard-disk drive (HDD) is used as an example environment in which to describe embodiments of the present invention, without limitation thereto. Therefore, descriptions given of embodiments of the present invention in terms of a HDD are not limiting, as embodiments of the present invention also include portable data-storage devices more generally, by way of example, solid-state drives (SSDs), flash memories, so-called “thumb” drives, and other portable data-storage devices both mechanical and solid state.

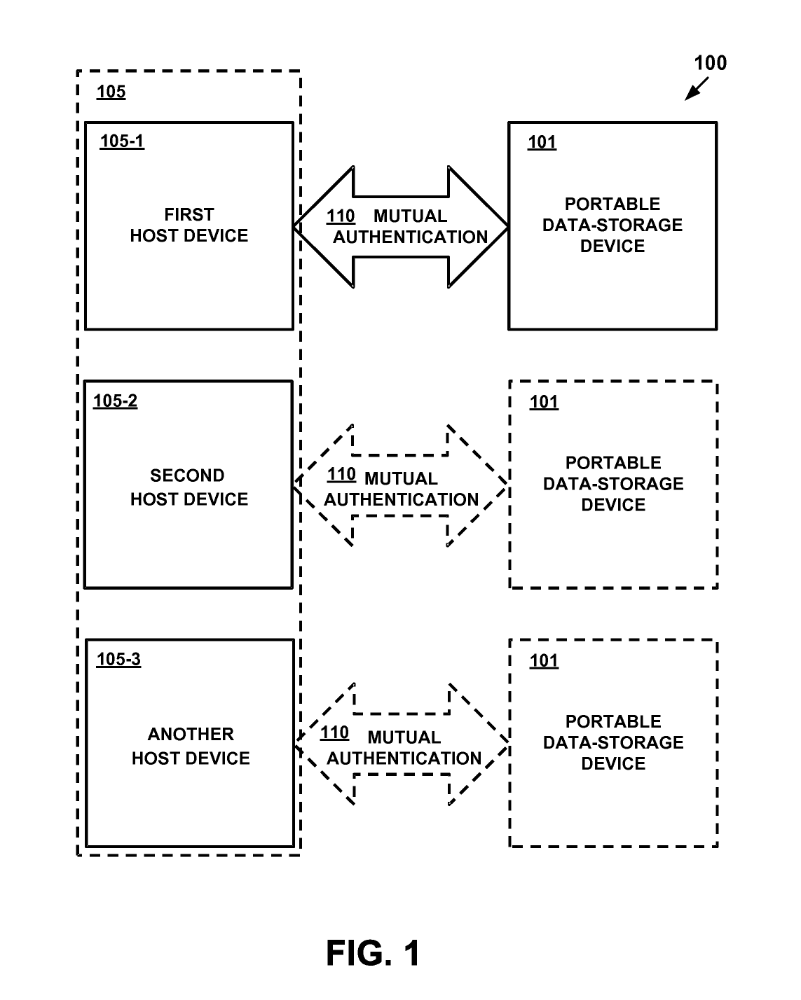

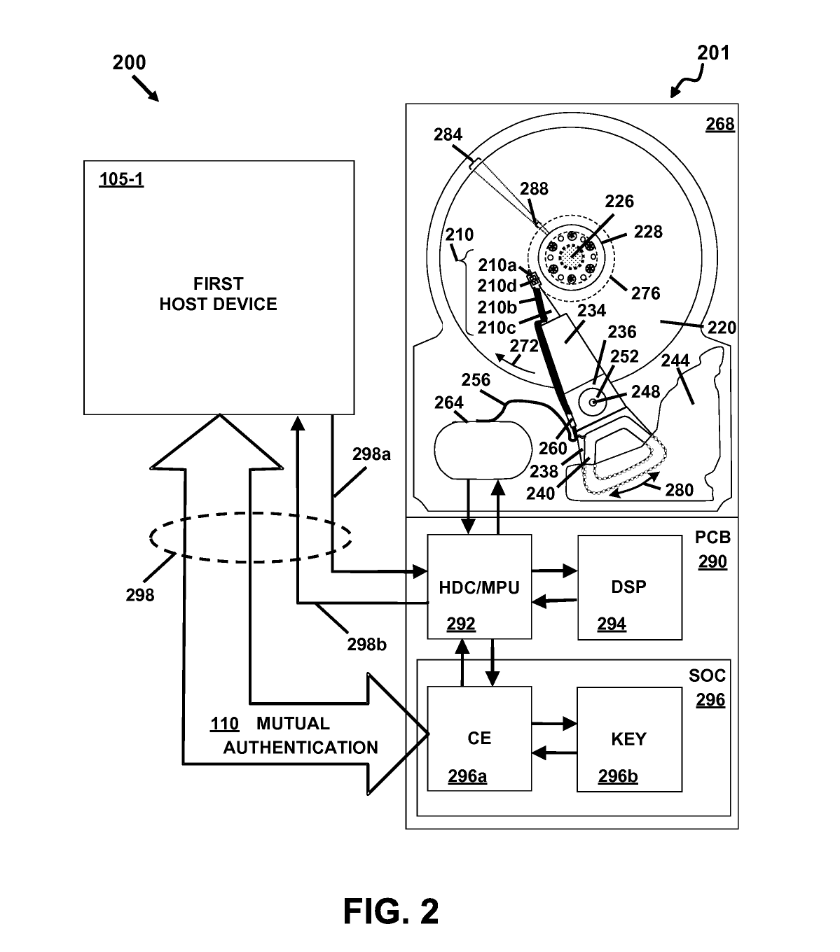

With reference now to FIG. 1, in accordance with embodiments of the present invention, a block diagram 100 of a portable data-storage device 101, by way of example, HDD 201 (see FIG. 2), without limitation thereto, and a plurality 105 of host devices is shown. The portable data-storage device 101 is configured to enable the plurality 105 of host devices, for example, host devices 105-1, 105-2, and 105-3, secure access to data through mutual authentication 110. The mutual authentication 110 includes a procedure by which the portable data-storage device 101 and one or more of host devices of the plurality 105 of host devices, for example, host devices 105-1, 105-2, and 105-3, are bound to one another for the secure transfer of data between the portable data-storage device 101 and one or more of host devices of the plurality 105 of host devices, for example, host devices 105-1, 105-2, and 105-3. By way of example, the data may include copyrighted content such as: audio/video content of motion pictures and television programs, audio content of digital music, gaming content of computer games, video content from books and magazines, computer-application content, computer-program content, without limitation thereto. By way of another example, the data may also include common-law copyrighted content such as: personal information, letters, photographs, financial records, medical records, and other personal content, without limitation thereto.

Mutual authentication includes sending a key from portable data-storage device 101 to a host device of the plurality 105 of host devices, for example, host devices 105-1, 105-2, and 105-3, which is recognized by the host device, and sending a key from the host device to portable data-storage device 101, which is recognized by portable data-storage device 101. Once the keys are mutually authenticated by the host device and portable data-storage device 101, portable data-storage device 101 is unlocked for the secure access of data on portable data-storage device 101 by the host device, for example, one or more of host devices 105-1, 105-2, and 105-3. The data on portable data-storage device 101 may be encrypted, for example, protected by digital rights management (DRM) software, for secure access by the host device. As used herein, software is performed as a sequence of machine-executable operations on a machine, such as for example, a computer, a processor unit, a microprocessor unit, an electronic authenticator, a system-on-chip (SOC), and/or any combination of a computer, a processor unit, a microprocessor unit, an electronic authenticator, and a SOC, without limitation thereto. Therefore, embodiments of the present invention include a portable data-storage device 101 that allows secure access to the data stored therein by a plurality 105 of host devices, by way of example, host devices 105-1, 105-2, and 105-3, such that the data is protected by mutual authentication in much the same way as data is protected in a DVR by the mutual authentication of an DVR-embedded storage device, by way of example, similar to HDD 201, without limitation thereto, with the display engine of the DVR using the DRM software, as accepted by industry standards, without limitation thereto. Thus, for example, a consumer would be able to use the portable data-storage device 101 to view copyrighted content downloaded onto a portable data-storage device 101 connected to a DVR, for example, first host device 105-1, and take the portable data-storage device 101 to another display engine, namely one host device of a plurality 105 of host devices, for example, one or more of host devices 105-2 and 105-3, for viewing. In one embodiment of the present invention, the data is accessed over a communication link 298 (see FIG. 2) between the host device of a plurality 105 of host devices, for example, host devices 105-1, 105-2, and 105-3, and the portable data-storage device 101, that is a wireless communication link, by way of example without limitation thereto, as is next described with reference to FIG. 2.

With reference now to FIG. 2 and further reference to FIG. 1, in accordance with one or more embodiments of the present invention, by way of example, a schematic diagram 200 is shown that illustrates the arrangement of components within a portable HDD 201, which is an example of portable data-storage device 101 of FIG. 1, without limitation thereto. In accordance with one or more embodiments of the present invention, portable HDD 201 includes a disk-enclosure base 268, which is an example storage-device enclosure, a magnetic-recording disk 220, which is an example data-storage medium, a magnetic-recording head 210a, which includes both an example data-writing element and an example data-reading element, and an electronic authenticator. In one embodiment of the present invention, by way of example without limitation thereto, the electronic authenticator may be a system-on-chip (SOC) 296, which is used herein to describe one embodiment of the electronic authenticator, as other embodiments of the electronic authenticator, for example, implemented on a plurality of integrated circuits, are also within the spirit and scope of embodiments of the present invention. As is known in the art, a SOC includes all, or most, of the electronic components of an electronic system for a specific task that are integrated onto a single integrated circuit. For example, a SOC may include a full computer system to execute the function of mutual authentication on a single integrated circuit.

With further reference to FIGS. 1 and 2, in accordance with other embodiments of the present invention, by way of example, in the environment of a solid state device, the data-storage medium may include a plurality of data-storage cells of a solid-state memory device; the data-writing element may include one or more driver circuits for writing data to the plurality of data-storage cells; and, the data-reading element may include one or more circuits for reading data from the plurality of data-storage cells, without limitation thereto. The magnetic-recording disk 220 is rotatably mounted in the disk-enclosure base 268. Thus, in accordance with one or more embodiments of the present invention, the magnetic-recording disk 220 is an example data-storage medium mounted in an example storage-device enclosure. In accordance with other embodiments of the present invention, by way of example, in the environment of a solid state device, the storage-device enclosure may include a package, such as a dual in-line (DIP) package with suitable encapsulation and pins, without limitation thereto. The magnetic-recording head 210a is configured to write data to, and to read the data from, the magnetic-recording disk 220. Thus, in accordance with one or more embodiments of the present invention, the magnetic-recording head 210a includes both an example data-writing element configured to write data to the data-storage medium, and an example data-reading element configured to read the data from data-storage medium.

With further reference to FIG. 2, in accordance with one or more embodiments of the present invention, the SOC 296 is configured to mutually authenticate the portable HDD 201, which is an example of portable data-storage device 101, with a first host device 105-1, and at least a second host device 105-2. The SOC 296 is configured to enable secure access to the data on the magnetic-recording disk 220, which is an example data-storage medium, by the first host device 105-1 if the SOC 296 mutually authenticates the portable HDD 201, which is an example of portable data-storage device 101, with the first host device 105-1. The SOC 296 is also configured to enable secure access to the data on the magnetic-recording disk 220, which is an example data-storage medium, by the second host device 105-2 if the SOC 296 mutually authenticates the portable HDD 201, which is an example of portable data-storage device 101, with the second host device 105-2, by way of example without limitation thereto, as secure access to one or more host devices of the plurality 105 of host devices is also within the spirit and scope of embodiments of the present invention.

With further reference to FIG. 2, in accordance with one or more embodiments of the present invention, portable HDD 201 also includes at least one HGA 210. The HGA 210 includes a head-slider including a slider 210d, and a magnetic-recording head 210a coupled with the slider 210d. The HGA 210 further includes a lead-suspension 210b attached to the head-slider, and a load beam 210c attached to the head-slider, which includes the magnetic-recording head 210a at a distal end of the head-slider. The head-slider is attached at the distal end of the load beam 210c. Portable HDD 201 also includes at least one magnetic-recording disk 220 rotatably mounted on a spindle 226 and a spindle motor (not shown) mounted in the disk-enclosure base 268 and attached to the spindle 226 for rotating the magnetic-recording disk 220. The magnetic-recording head 210a that includes a data-writing element, a so-called writer, and a data-reading element, a so-called reader, is disposed for respectively writing and reading information, referred to by the term of art, “data,” stored on the magnetic-recording disk 220 of portable HDD 201. The magnetic-recording disk 220, or a plurality (not shown) of magnetic-recording disks, are affixed to the spindle 226 with a disk clamp 228. Portable HDD 201 further includes an actuator arm 234 attached to HGA 210, a carriage 236, a voice-coil motor (VCM) that includes an armature 238 including a voice coil 240 attached to the carriage 236; and a stator 244 including a voice-coil magnet (not shown); the armature 238 of the VCM is attached to the carriage 236 and is configured to move the actuator arm 234 and HGA 210 to access portions of the magnetic-recording disk 220, as the carriage 236 is mounted on a pivot-shaft 248 with an interposed pivot-bearing assembly 252.

With further reference to FIG. 2, in accordance with one or more embodiments of the present invention, electrical signals, for example, current to the voice coil 240 of the VCM, write signals to and read signals from the magnetic-recording head 210a, are provided by a flexible cable 256. Interconnection between the flexible cable 256 and the magnetic-recording head 210a may be provided by an arm-electronics (AE) module 260, which may have an on-board pre-amplifier for the read signal, as well as other read-channel and write-channel electronic components. The flexible cable 256 is coupled to an electrical-connector block 264, which provides electrical communication through electrical feedthrough as part of the disk-enclosure base 268 to electronic components mounted on the printed circuit board (PCB) 290 that unlock the portable HDD 201 for the access of data, including copyrighted content, stored on the magnetic-recording disk 220. The disk-enclosure base 268 may include a casting, depending upon whether the disk-enclosure base 268 is cast. The disk-enclosure base 268 in conjunction with an HDD cover (not shown) provides a sealed protective disk enclosure for the information storage components of portable HDD 201.

With further reference to FIG. 2, in accordance with one or more embodiments of the present invention, electronic components that may be mounted on the PCB 290, include a hard-disk controller/microprocessor (HDC/MPU) 292 and servo electronics including a digital-signal processor (DSP) 294, which provide electrical signals to the spindle motor, the voice coil 240 of the VCM, and the magnetic-recording head 210a of HGA 210. The electrical signal provided to the spindle motor enables the spindle motor to spin providing a torque to the spindle 226 which is in turn transmitted to the magnetic-recording disk 220 that is affixed to the spindle 226 by the disk clamp 228; as a result, the magnetic-recording disk 220 spins in direction 272. The spinning magnetic-recording disk 220 creates an airflow including an air-stream, and a self-acting air bearing on which the air-bearing surface (ABS) of the head-slider rides so that the head-slider flies in proximity with the recording surface of the magnetic-recording disk 220 to avoid contact with a thin magnetic-recording medium of the magnetic-recording disk 220 in which information, including data, is recorded. The electrical signal provided to the voice coil 240 of the VCM enables the magnetic-recording head 210a of HGA 210 to access a track 276 on which information is recorded. As used herein, “access” is a term of art that refers to operations in seeking the track 276 of the magnetic-recording disk 220 and positioning the magnetic-recording head 210a on the track 276 for both reading data from, and writing data to, the magnetic-recording disk 220.

With further reference to FIG. 2, in accordance with one or more embodiments of the present invention, the armature 238 of the VCM swings through an arc 280 which enables HGA 210 attached to the armature 238 by the actuator arm 234 to access various tracks on the magnetic-recording disk 220. Information is stored on the magnetic-recording disk 220 in a plurality of concentric tracks (not shown) arranged in sectors on the magnetic-recording disk 220, for example, sector 284. Correspondingly, each track is composed of a plurality of sectored track portions, for example, sectored track portion 288. Each sectored track portion 288 is composed of recorded data and a header containing a servo-burst-signal pattern, for example, an ABCD-servo-burst-signal pattern, information that identifies the track 276, and error correction code information. In accessing the track 276, the data-reading element of the magnetic-recording head 210a of HGA 210 reads the servo-burst-signal pattern which provides a position-error-signal (PES) to the servo electronics, which controls the electrical signal provided to the voice coil 240 of the VCM, enabling the magnetic-recording head 210a to follow the track 276. Upon finding the track 276 and identifying a particular sectored track portion 288, the magnetic-recording head 210a either reads data from the track 276, or writes data to, the track 276 depending on instructions received by HDC/MPU 292, for example, from an external agent such as a microprocessor of a computer system, without limitation thereto. In accordance with one or more embodiments of the present invention, such instructions may include an unlocking instruction to unlock the portable HDD 201 for the access of data after mutual authentication has been established between the portable HDD 201 and a host device of the plurality 105 of host devices, for example, one or more of host devices 105-1, 105-2, and 105-3. The unlocking instruction may be sent to the HDC/MPU 292 from SOC 296, as is next described.

With further reference to FIG. 2, in accordance with one or more embodiments of the present invention, the PCB 290 may also include SOC 296. SOC 296 includes a cryptographic engine (CE) 296a and a key 196b. By way of example without limitation thereto, in one embodiment of the present invention, the SOC 296 may employ a security technique for mutual authentication 110 similar to that described in U.S. Pat. No. 7,971,241, “TECHNIQUES FOR PROVIDING VERIFIABLE SECURITY IN STORAGE DEVICES,” of Cyril Guyot, et al., wherein portable HDD 201 is authenticated with one or more of host devices of the plurality 105 of host devices, for example, host devices 105-1, 105-2, and 105-3. After portable HDD 201 is mutually authenticated with a host device, for example, host device 105-1, SOC 296 sends an unlocking instruction to HDC/MPU 292 to allow the host device, for example, host device 105-1, to access data, including content, on the magnetic-recording disk 220. The data on the magnetic-recording disk 220 may be encrypted for the purpose of digital rights management (DRM) on the magnetic-recording disk 220 which may require further decrypting by the CE 296a before being sent by HDC/MPU 292 for transmission to the host device for display, and/or output in a suitable form for perception by a consumer.

As shown in FIG. 2, in one embodiment of the present invention, communication link 298 includes a channel for mutual authentication 110, a channel 298a for the transfer of instructions and data from the first host device 105-1 to portable HDD 201, and a channel 298b for the transfer of instructions and data from portable HDD 201 to the first host device 105-1. In an embodiment of the present invention, after a key recognized by portable HDD 201 and first host device 105-1 is verified by mutual authentication 110 through SOC 296, data may be transferred on channel 298b to the first host device 105-1, which may include a display engine, for example, a personal computer (PC); and, instructions, for example, for fetching data from the magnetic-recording disk 220 of portable HDD 201, may be received by portable HDD 201 from the first host device 105-1 on channel 298a. In accordance with embodiments of the present invention, the host device, for example host device 105-1, and the portable HDD 201 may also include (not shown) suitable drivers, and/or transmitters and receivers for transmission and reception, respectively, of information conveyed between the portable HDD 201 and the host device on communication link 298.

With further reference to FIG. 2, in accordance with one or more embodiments of the present invention, the first host device 105-1 may include a set-top box, which may be a DVR. In one embodiment of the present invention, the second host device 105-2 may include a computer-based media player. In one or more embodiments of the present invention, the computer-based media player may be selected from the group consisting of a personal computer, a tablet computer, a smart phone, a media player, and a digital television. In one embodiment of the present invention, the portable HDD 201 may be configured to be directly attached by communication link 298 to at least one host device, for example, first host device 105-1, or alternatively, second host device 105-2, of the plurality 105 of host devices, for example, host devices 105-1, 105-2, and 105-3. Alternatively, in another embodiment of the present invention, the portable HDD 201 may be configured to be network attached by communication link 298 to at least one host device, for example, first host device 105-1, or alternatively, second host device 105-2, of the plurality 105 of host devices, for example, host devices 105-1, 105-2, and 105-3. In another embodiment of the present invention, the portable HDD 201 may be configured to be attached wirelessly by communication link 298 to at least one host device, for example, first host device 105-1, or alternatively, second host device 105-2, of the plurality 105 of host devices, for example, host devices 105-1, 105-2, and 105-3. In another embodiment of the present invention, the data may include copyrighted content. In another embodiment of the present invention, secure access may include digital rights management (DRM).

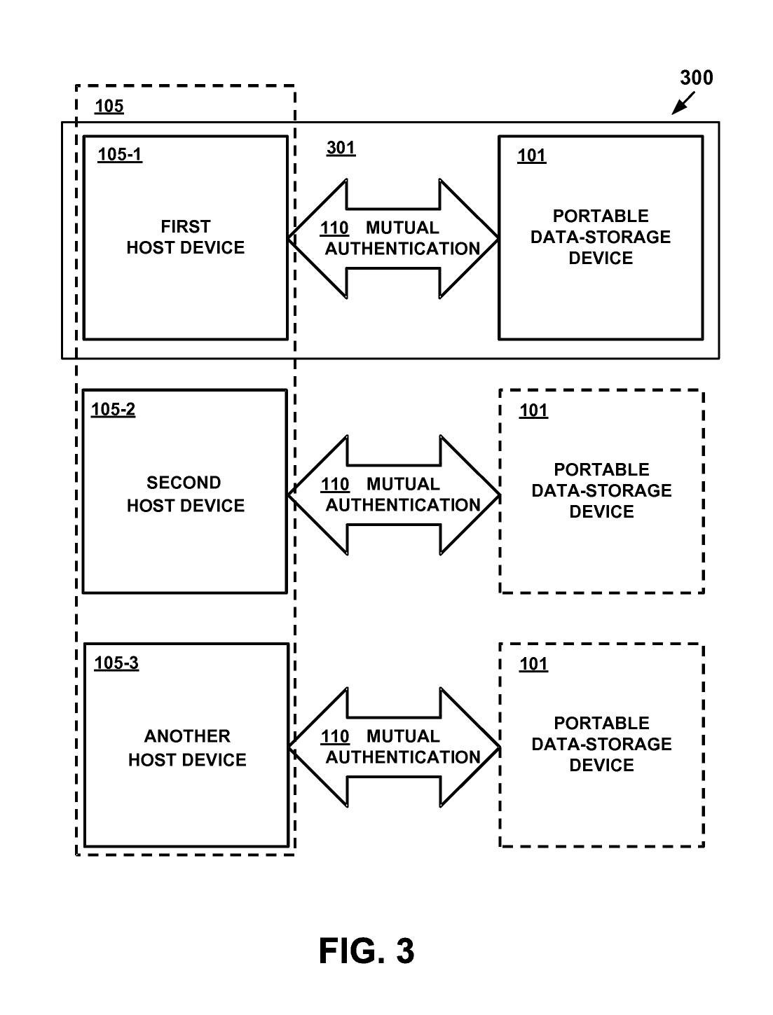

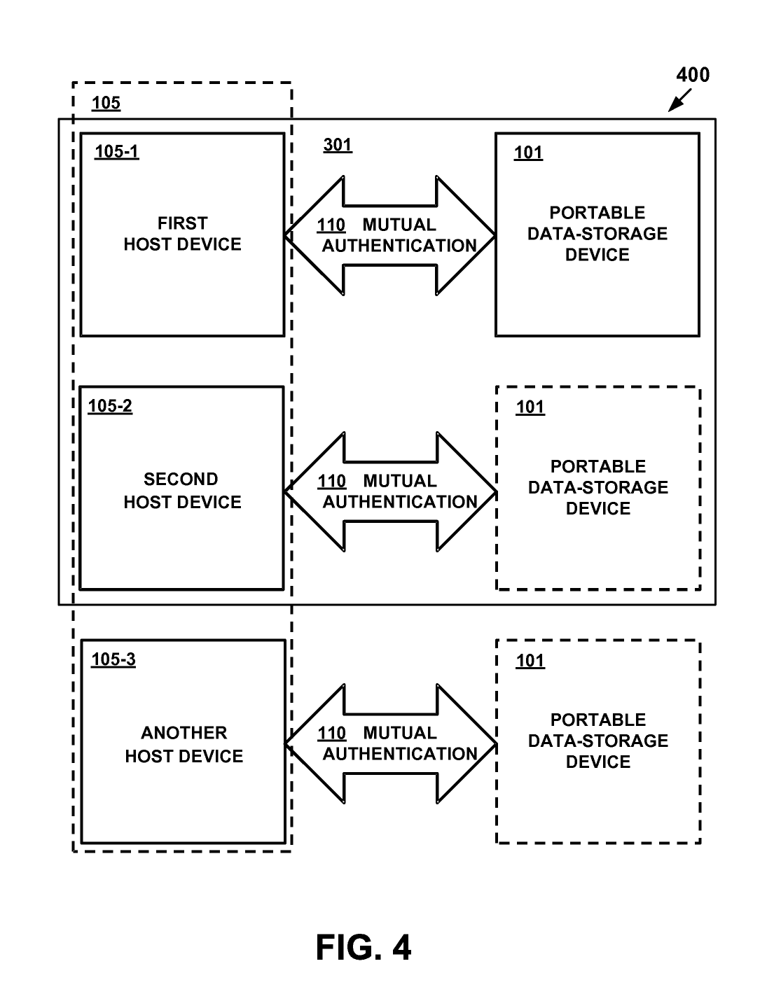

With reference now to FIGS. 3 and 4, in accordance with embodiments of the present invention, block diagrams 300 and 400 are shown of examples of a system 301 that is configured to enable the plurality 105 of host devices secure access to data stored on the portable data-storage device 101 of FIG. 1 through mutual authentication 110. As shown in FIG. 3, the system 301 includes a first host device 105-1 and portable data-storage device 101. As shown in FIG. 4, the system 301 includes a first host device 105-1, at least a second host device 105-2 and portable data-storage device 101. In accordance with embodiments of the present invention, the system 301 includes embodiments of the present invention for the portable data-storage device 101 as previously described in the description of the environment of HDD 201 of FIG. 2. Therefore, by way of example, portable data-storage device 101 of the system 301 may include a disk-enclosure base 268, a magnetic-recording disk 220, a magnetic-recording head 210a, and a SOC 296, without limitation thereto. The magnetic-recording disk 220 is rotatably mounted in the disk-enclosure base 268. The magnetic-recording head 210a is configured to write data to, and to read the data from, the magnetic-recording disk 220. The SOC 296 is configured to mutually authenticate the portable data-storage device 101 with a first host device 105-1, and at least a second host device 105-2. The SOC 296 is configured both to enable secure access to the data on the magnetic-recording disk 220 by the first host device 105-1 if the SOC 296 mutually authenticates the portable data-storage device 101 with the first host device 105-1, and to enable secure access to the data on the magnetic-recording disk 220 by the second host device 105-2 if the SOC 296 mutually authenticates the portable data-storage device 101 with the second host device 105-2.

Moreover, with further reference to FIGS. 3 and 4, other embodiments of the present invention described herein for portable data-storage device 101 may be incorporated within the environment of the system 301. Thus, in an embodiment of the present invention, the system 301 may further include at least a second host device 105-2 such that at least one of the first host device 105-1 and the second host device 105-2 is directly attached by communication link 298 to the portable data-storage device 101. In another embodiment of the present invention, the system 301 may further include at least one of the first host device 105-1 and the second host device 105-2 that is network attached by communication link 298 to the portable data-storage device 101. Alternatively, in another embodiment of the present invention, the system 301 may further include one of the first host device 105-1 and the second host device 105-2 that is directly attached by communication link 298 to the portable data-storage device 101, and another of the first host device 105-1 and the second host device 105-2 that is network attached by another communication link 298 to the portable data-storage device 101. In another embodiment of the present invention, the system 301 may include a first host device 105-1 that includes a set-top box. In other embodiments of the present invention, the system 301 may include a second host device 105-2 that is selected from the group consisting of a personal computer, a tablet computer, a smart phone, a media player, and a digital television. In another embodiment of the present invention, the system 301 may include data that includes copyrighted content. In another embodiment of the present invention, the system 301 may include secure access that includes digital rights management (DRM).

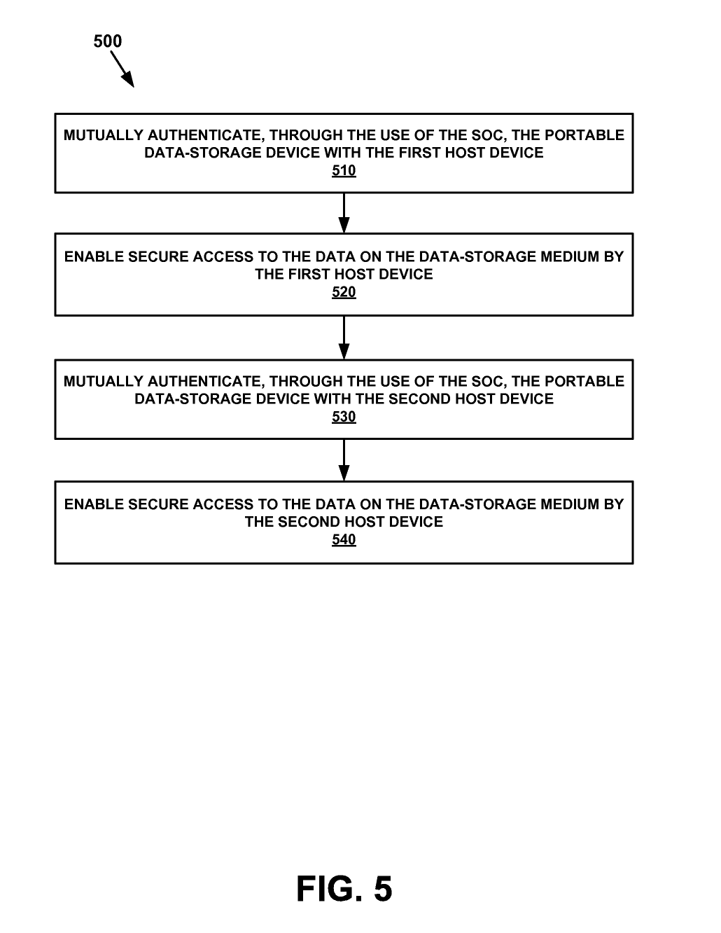

With reference now to FIG. 5, in accordance with embodiments of the present invention, a flowchart 500 is shown of a method for enabling a plurality of host devices secure access to data stored in a portable data-storage device through mutual authentication. The portable data-storage device is provided to include a data-storage medium configured for storing and accessing the data, and an electronic authenticator, by way of example without limitation thereto, a SOC, configured to mutually authenticate the portable data-storage device with a host device of the plurality of host devices. The plurality of host devices is provided to include a first host device and a second host device. A first communication link is provided to couple the portable data-storage device coupled to the first host device. A second communication link is provided to couple the portable data-storage device coupled to the second host device.

With further reference to FIG. 5, in accordance with embodiments of the present invention, the method includes the following machine-executable operations performed by a machine, such as for example, a computer, a processor unit, a microprocessor unit, an electronic authenticator, a SOC, and/or any combination of a computer, a processor unit, a microprocessor unit, an electronic authenticator, and a SOC, without limitation thereto. At 510, through use of the electronic authenticator, the portable data-storage device is mutually authenticated with the first host device. At 520, secure access is enabled to the data on the data-storage medium by the first host device. At 530, through use of the electronic authenticator, the portable data-storage device is mutually authenticated with the second host device. At 540, secure access is enabled to the data on the data-storage medium by the second host device.

Moreover, embodiments of the present invention described herein for the portable data-storage device may be incorporated within the method. For example, the first host device may include a set-top box. In another embodiment of the present invention, the second host device may be selected from the group consisting of a personal computer, a tablet computer, a smart phone, a media player, and a digital television. In another embodiment of the present invention, the data may include copyrighted content. In another embodiment of the present invention, the secure access may include digital rights management (DRM).

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A portable data-storage device configured to enable a plurality of host devices secure access to data through mutual authentication, said portable data-storage device comprising:
a storage-device enclosure;
a data-storage medium enclosed in said storage-device enclosure;
a data-writing element configured to write data to said data-storage medium;
a data-reading element configured to read said data from data-storage medium; and
an electronic authenticator configured to mutually authenticate said portable data-storage device with a first host device and with at least a second host device of said plurality of host devices;
wherein said electronic authenticator is configured to enable secure access to said data on said data-storage medium by said first host device if said electronic authenticator mutually authenticates said portable data-storage device with said first host device; and
wherein said electronic authenticator is configured to enable secure access to said data on said data-storage medium by said second host device if said electronic authenticator mutually authenticates said portable data-storage device with said second host device.

2. The portable data-storage device of claim 1, wherein said first host device comprises a set-top box.

3. The portable data-storage device of claim 2, wherein said set-top box comprises a digital-video recorder.

4. The portable data-storage device of claim 1, wherein said second host device comprises a computer-based media player.

5. The portable data-storage device of claim 4, wherein said computer-based media player comprises a host device selected from the group consisting of a personal computer, a tablet computer, a smart phone, a media player, and a digital television.

6. The portable data-storage device of claim 1, wherein said portable data-storage device is configured to be directly attached to at least one host device of said plurality of host devices.

7. The portable data-storage device of claim 1, wherein said portable data-storage device is configured to be network attached to at least one host device of said plurality of host devices.

8. The portable data-storage device of claim 1, wherein said portable data-storage device is configured to be attached wirelessly to at least one host device of said plurality of host devices.

9. The portable data-storage device of claim 1, wherein said electronic authenticator comprises a system-on-chip.

10. The portable data-storage device of claim 1, wherein said secure access comprises digital rights management.

11. A system configured to enable a plurality of host devices secure access to data stored on a portable data-storage device through mutual authentication, said system comprising:
a first host device; and
a portable data-storage device, comprising:
a storage-device enclosure;
a data-storage medium enclosed in said storage-device enclosure;
a data-writing element configured to write data to said data-storage medium;
a data-reading element configured to read said data from data-storage medium; and
an electronic authenticator configured to mutually authenticate said portable data-storage device with a first host device and with at least a second host device of said plurality of host devices;
wherein said electronic authenticator is configured to enable secure access to said data on said data-storage medium by said first host device if said electronic authenticator mutually authenticates said portable data-storage device with said first host device; and
wherein said electronic authenticator is configured to enable secure access to said data on said data-storage medium by said second host device if said electronic authenticator mutually authenticates said portable data-storage device with said second host device.

12. The system of claim 11, further comprising:
at least said second host device.

13. The system of claim 12, wherein said at least one of said first host device and said second host device is directly attached to said portable data-storage device.

14. The system of claim 13, wherein at least one of said first host device and said second host device is network attached to said portable data-storage device.

15. The system of claim 13, wherein one of said first host device and said second host device is directly attached to said portable data-storage device, and another of said first host device and said second host device is network attached to said portable data-storage device.

16. The system of claim 11, wherein said first host device comprises a set-top box.

17. The system of claim 11, wherein said second host device is selected from the group consisting of a personal computer, a tablet computer, a smart phone, a media player, and a digital television.

18. The system of claim 11, wherein said electronic authenticator comprises a system-on-chip.

19. The system of claim 11, wherein said secure access comprises digital rights management.

20. A method for enabling a plurality of host devices secure access to data stored in a portable data-storage device through mutual authentication, said portable data-storage device including a data-storage medium configured for storing and accessing said data, and an electronic authenticator configured to mutually authenticate said portable data-storage device with a host device of said plurality of host devices, said plurality of host devices including a first host device and a second host device, and such that a first communication link is configured to couple said portable data-storage device to said first host device by, and a second communication link is configured to couple said portable data-storage device to said second host device, said method comprising:
the following machine-executable operations performed with said electronic authenticator:
mutually authenticating with said electronic authenticator said portable data-storage device and said first host device;
enabling secure access to said data stored in said data-storage medium by said first host device;
mutually authenticating with said electronic authenticator said portable data-storage device and said second host device; and
enabling secure access to said data stored in said data-storage medium by said second host device.

21. The method of claim 20, wherein said first host device comprises a set-top box.

22. The method of claim 20, wherein said second host device is selected from the group consisting of a personal computer, a tablet computer, a smart phone, a media player, and a digital television.

23. The method of claim 20, wherein said electronic authenticator comprises a system-on-chip.

24. The method of claim 20, wherein said secure access comprises digital rights management.
